(19) United States
(12) Patent Application Publication
(10) Pub. No.: US 2024/0388599 A1
(43) Pub. Date: Nov. 21, 2024

(54) SYSTEM AND METHOD FOR AUTOMATION OF LIVE TECHNICAL CONTROL RISK MANAGEMENT AND ADJUSTMENT OF CYBER-INSURANCE AVAILABILITY AND COVERAGE

(71) Applicant: Sirius Assurance, Chicago, IL (US)

(72) Inventor: Richard HUNTER, Chicago, IL (US)

(73) Assignee: Sirius Assurance, Chicago, IL (US)

(21) Appl. No.: 18/412,188

(22) Filed: Jan. 12, 2024

Related U.S. Application Data
(60) Provisional application No. 63/438,738, filed on Jan. 12, 2023.

(51) Int. Cl. H04L 9/40

(52) U.S. Cl. CPC H04L 63/1441

(57) ABSTRACT

Systems and methods are provided for automation of live technical control risk management and adjustment thereof. An example method comprises receiving operational data related to an operation of one or more technical controls installed in a data sensitive system, the one or more technical controls provided by a provider; processing the operational data; sending the processed operational data to a first device, the first device configured to perform smart contract operations; detecting, by the first device, a fault in the operation of one or more technical controls based on the processed operational data; sending, by the first device, first signals to an oracle device; sending, by the oracle device, second signals to one or more devices; and displaying results data.

### CROSS-REFERENCE TO RELATED APPLICATIONS

This application claims the benefit of priority from U.S. Provisional Application No. 63/438,738, filed on Jan. 12, 2023, the disclosure of which is herein incorporated by reference in its entirety.

### FIELD OF THE DISCLOSURE

Embodiments of this disclosure relate to services utilizing smart contracts to automatically manage risks.

### BACKGROUND

Technical controls are the hardware and software components that protect a system against cyberattacks or unavailability. Examples of technical controls are firewalls, intrusion detection systems (IDS), encryption, and identification and authentication mechanisms. At present, the process for imposing accountability on contract counterparties (e.g., vendors and insureds) for their promises to implement and maintain effective technical controls in monitoring and minimizing or preventing data breaches, other compromises of sensitive or proprietary information, or other conditions that contribute to manufacturing and service delivery system failures is resource-intensive, is not conducted uniformly across large segments of counterparties, and largely remains limited to circumstances when audits are conducted (usually in the wake of significant incidents like data breaches).

The consequences of this lack of visibility are compounded for other stakeholders. Vendors that fail their clients have also failed their clients' customers. Clients who cannot determine what their vendors are doing are hard-pressed to make representations to others, such as their customers, regulators, and insurers. Moreover, as between insurers and insureds, when significant incidents occur and potentially trigger insurance coverage, lengthy and costly coverage disputes often ensue, centering upon whether reasonable controls expectations were met (to prevent or mitigate the harm that is the subject of the insurance coverage).

Most large organizations that are dependent upon vendors for manufacturing, IT, marketing, and service delivery have very limited ability to determine whether or not those vendors are adhering to their contractual obligations. This is particularly true for obligations that relate to controls intended to make sure that those vendors can continue to provide uninterrupted service and protect the confidentiality, integrity and availability of data. When those vendors do not fulfill those obligations and fail to implement controls like periodic data backups, encryption, and multi-factor authentication, their customers often do not find out until the failure or unavailability of those controls results in a data security or unavailability incident-too late.

Examples of effective technical controls that are often linked to significant incidents include the following:
Multi-factor authentication (as a means of access control intended to prevent network intrusion, attacks, and compromises of sensitive data)
Encryption (as a means to limit the damage caused by exposure of sensitive data)
Data backups (as a means to limit damage caused by system failures and ransomware attacks)

These controls are all capable of being automatically monitored continuously or regularly for proper configuration and effectiveness. Where such controls are not implemented, the risk to an organization is appreciably greater, and so increased emphasis has been placed on the implementation of these controls both within organizations and within their extended infrastructure, e.g., within the walls of their vendors.

### SUMMARY OF THE DISCLOSURE

The present disclosure is directed to automating and better rationalizing, with meaningful data, two processes: managing third parties to ensure that they are living up to their contractual obligations; and linking the cost and availability of cyber-liability insurance more directly to actual cyber-risk. The benefits of such a system include the following:

Organizations that employ vendors will be able to use the system to: monitor vendors' implementation and maintenance of required controls using a smart contract platform, will be able to provide better evidence of compliance, and will be able to hold vendors accountable based on evidence of non-compliance through automatic implementation of consequences as enumerated in the software code of a smart contract. That accountability can include termination of services or contract penalties, applied automatically via the smart contract.

Organizations that are insureds will be able to use the system to collect and provide data regarding their cyber risk to insurers or potential insurers.

Insurance carriers that provide insurance to these organizations will be able to use the system to better evaluate and potentially dynamically price the risk their insureds' vendors (and thus the insureds themselves) present using data collected by the system, along with potentially being able to automatically condition availability of insurance on the implementation or re-institution of controls that the system automatically detects as non-existent or non-functioning.

Embodiments of the present disclosure are directed to systems, methods, and computer-readable media for live counterparty risk management. An example method comprises a receiving operational data related to an operation of one or more technical controls installed in a data sensitive system, the one or more technical controls provided by a provider; processing the operational data; sending the processed operational data to a first device, the first device configured to perform smart contract operations; detecting, by the first device, a fault in the operation of one or more technical controls based on the processed operational data; sending, by the first device, first signals to an oracle device; sending, by the oracle device, second signals to one or more devices; and displaying results data.

Systems and computer-readable media (such as non-transitory computer-readable media) that implement the above method are also provided.

Additional objects and advantages of the embodiments will be set forth in part in the description which follows, and in part will be obvious from the description, or may be learned by practice. The objects and advantages will be realized and attained by means of the elements and combinations particularly pointed out in the appended claims.

It is to be understood that both the foregoing general description and the following detailed description are exemplary and explanatory only and are not restrictive of the claims.

### BRIEF DESCRIPTION OF THE DRAWINGS

The accompanying drawings, which are incorporated in and constitute a part of this specification, illustrate several embodiments and together with the description, serve to explain some principles.

FIG. 1 illustrates an example system for use in implementing the disclosed embodiments.

FIG. 2 illustrates an example organizational relationship diagram, consistent with the disclosed embodiments.

FIG. 3 illustrates an example data flow process, consistent with the disclosed embodiments.

FIG. 4 illustrates an example process for a smart contract platform, consistent with the disclosed embodiments.

FIG. 5 illustrates an example process for operation of a smart contract by a device, consistent with the disclosed embodiments.

### DETAILED DESCRIPTION

Example embodiments of this disclosure are related to enhancing users' ability to automate technical control risk management using a smart contract. The smart contract may include conditions that, when triggered, cause a system to implement an automatic consequence to a party of the smart contract.

More specifically, some embodiments may include automatically monitoring and assessing the implementation of technical controls using a smart contract. Some embodiments may also include automatically charging a party in violation of a smart contract. Some embodiments may also include automatically adjusting insurance pricing, availability, or coverage based on assessed implementation of technical controls.

Reference will now be made in detail to various embodiments, examples of which are illustrated in the accompanying drawings. Wherever possible, the same reference numbers will be used throughout the drawings to refer to the same or like parts.

Certain embodiments of the present disclosure may involve a processor, which may refer to one or more electronic processors, such as, for example, desktop processors, server processors, mobile processors, such as Intel Core processors, AMD Ryzen processors, Intel Xeon processors, Qualcomm Snapdragon processors, or the like.

The disclosed systems may be implemented in part or in full on various computers, electronic devices, computer-readable media (such as CDs, DVDs, flash drives, hard drives, or other storage), or other electronic devices or storage devices. The methods and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit). While disclosed processes include particular process flows, alternative flows or orders are also possible in alternative embodiments.

Certain embodiments of the present disclosure may involve a blockchain, which may refer to a decentralized and distributed digital ledger technology that enables secure and transparent record-keeping of transactions across a network of computers. Some types of blockchains include public blockchain, private blockchain, and hybrid blockchain. A public blockchain is a type of blockchain that is open and permissionless such that any user may participate, validate transactions, contribute to the consensus process, or perform any other action relating to the blockchain. Public blockchains are decentralized and their data are accessible by any user. Non-limiting examples of public blockchains include Bitcoin, Ethereum, and Solana. A private blockchain is a type of blockchain that is restricted and permissioned such that only authorized users may access the blockchain network, validate transactions, participate in the consensus mechanism, or any other action relating to the blockchain. Private blockchains provide more control over which users can interact with the blockchain network. Non-limiting examples of private blockchains include Hyperledger Fabric, R3 Corda, and Ripple. A hybrid blockchain is a type of blockchain that combines elements of public blockchains and private blockchains such that authorized users may perform private transactions and any user may view public data or nodes. Non-limiting examples of hybrid blockchains include Dragonchain and Aion. It may be understood that the term “blockchain,” as used herein, may refer to any type of blockchain, including but not limited to those described above.

Certain embodiments of the present disclosure may involve a smart contract, which may refer to a self-executing contract with the terms of the agreement between two parties being directly written into lines of software code. The code and the agreements contained therein exist across a distributed, decentralized blockchain network. The code controls the execution, and transactions are trackable and irreversible. Smart contracts permit trusted transactions and agreements to be carried out among disparate, anonymous parties without the need for a central authority, legal system, or external enforcement mechanism. For example, a smart contract may be used in place of a traditional escrow arrangement where cash or an item of value is held be a third party and released upon the occurrence of a separate act. Smart contracts are configured such that its terms and the execution of the contract are all data accessible to anyone who can access the blockchain on which the smart contract resides. For example, in some embodiments the data may reside on a decentralized public blockchain (such as the Ethereum blockchain), in which case any user may access the smart contract and its data. Further, in some embodiments, one or more systems operated by one or more entities, such as insurers or a trusted third party, may be used to host a permissioned blockchain that is not accessible to the general public to ensure greater data recording and access efficiency, security, and confidentiality.

Certain embodiments of the present disclosure may involve a platform, which may refer to a computing environment in which computer software is executed. For example, a platform may include a web browser, an application, a virtual machine, or the like. A platform may be run or hosted on one computing device and displayed, via an interface, on the same or another computing device. A platform may be configured to receive data or information from a computing device or another platform. Further, a platform may be configured to send data or information to a computing device or another platform. For example, a platform may receive technical controls status data from a platform that implements a technical control and may send the technical controls status data to another platform.

Certain embodiments of the present disclosure may involve technical controls status data, which may refer to data that contains information associated with the status or functionality of a technical control. For example, technical controls status data may include if a firewall is active, if multi-factor authorization is enabled, or the like. In some embodiments, technical controls status data may be generated by a platform, such as a controls provider platform. In some embodiments, technical controls status data may be sent, from the platform that generates them, to another platform, such as a continuous controls monitoring platform. Further, in some embodiments, a platform may query or request another platform to generate and send technical controls status data. For example, a continuous controls monitoring platform may query or request a controls provider platform to generate and send technical controls status data. Further, in some embodiments, a platform may monitor another platform and generate technical controls status data based on the monitored activity of the other platform. For example, a continuous controls monitoring platform may monitor the activity, implementation, or function of a controls provider platform and generate associated technical controls status data.

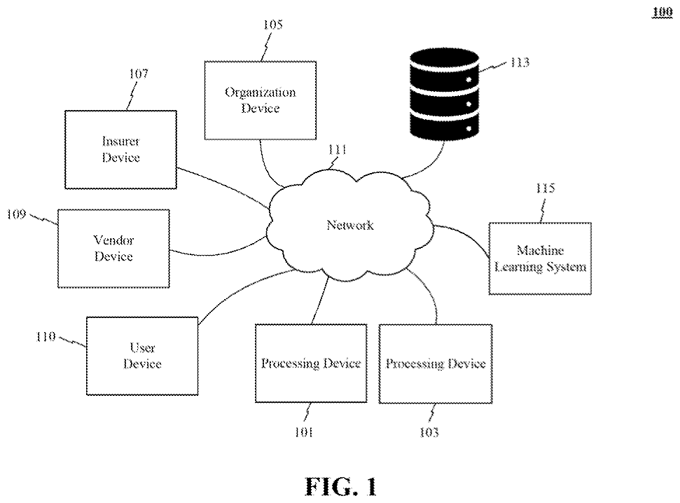

FIG. 1 is a system 100 for using in implementing the disclosed embodiments. System 100 may comprise processing device 101, processing device 103, organization device 105, insurer device 107, vendor device 109, user device 110, network 111, database 113, and machine learning system 115. One of ordinary skill will understand that particular devices in system 100 can be duplicated, omitted, or modified, as appropriate.

In some embodiments, each device illustrated in FIG. 1 may be operated by separate parties. However, in other embodiments, each party may operate or administer more than one of the devices illustrated in FIG. 1. For example, a single entity may operate any or all of processing device 101, processing device 103, organization device 105, and database 113. Additionally, in some embodiments, one of the illustrated devices in FIG. 1 may be combined with one or more other illustrated devices. For example, processing device 101, processing device 103, and database 113 may be combined into a single device or system.

Generally, it may be understood that any of the devices illustrated in FIG. 1 may communicate with any other device illustrated in FIG. 1 using a wireless network, mobile network, a satellite network, a physical data line, or the like (e.g., network 111 or another network). Further, it may be understood that any of the devices illustrated in FIG. 1 may execute computer instructions associated with a blockchain or smart contract.

Processing device 101 represents one or more electronic devices configured to perform a task. Processing device 101 may include or one or more known processors, such as, for example, a microprocessor. In some embodiments, processing device 101 may include any type of single or multi-core processor, mobile device microcontroller, central processing unit, or any circuitry that performs logic operations. In operation, processing device 101 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in processing device 101, or elsewhere.

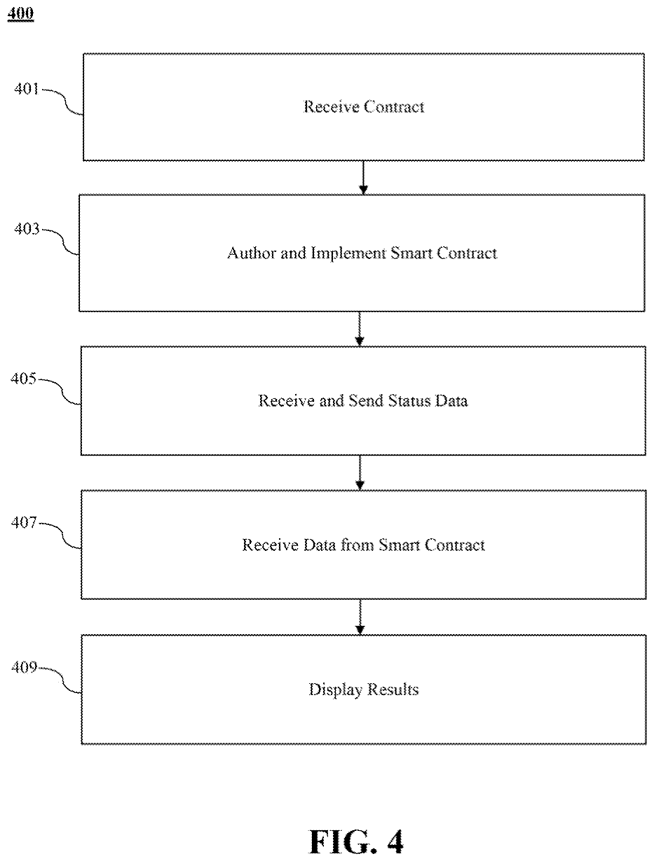

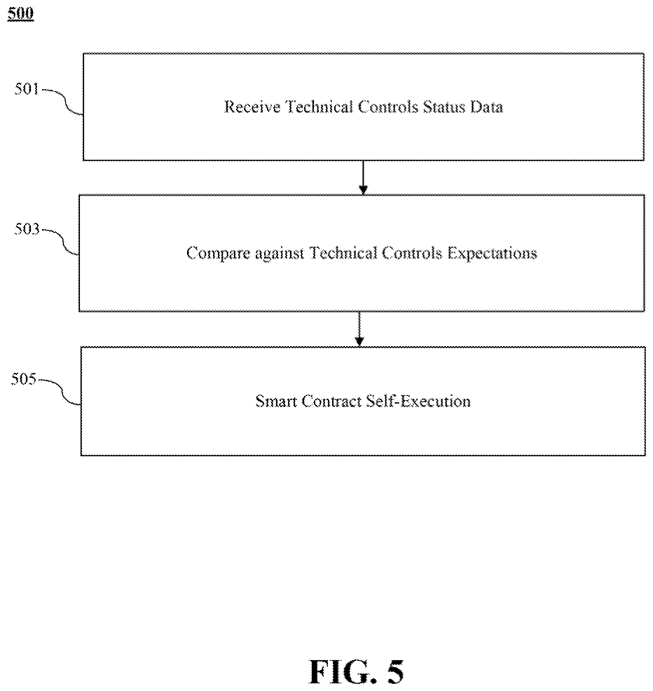

In some embodiments, processing device 101 may be configured to run or bost a platform configured to perform operations consistent with disclosed embodiments for use on a device, such as organization device 105. In some embodiments, processing device 101 may be configured to run or host a smart contract platform. A smart contract platform may refer to a platform configured to perform operations related to the creation, implementation, operation and/or display of a smart contract, as exemplified and described with respect to FIGS. 4 and 5.

In some embodiments, the smart contract platform may be configured to communicate with a device or another platform. For example, the smart contract platform may be configured to receive data from another platform, such as a continuous controls monitoring (CCM) platform. Further, the smart contract platform may be configured to send data to another device, such as organization device 105. In some embodiments, the smart contract platform may be configured to communicate with machine learning system 115 to perform or assist with performing one or more operations consistent with disclosed embodiments.

In some embodiments, the smart contract platform may further be configured to receive data from a user. Receiving data, as used herein, may refer to accepting, taking in, admitting, gaining, acquiring, retrieving, obtaining, reading, accessing, collecting, or any operation for inputting the data. The smart contract platform may be configured to accept free form text, spoken language, or a combination of free form text and spoken language as inputs. The smart contract platform may further be configured to accept files as input, such as PDF files, DOC files, DOCX files, TXT files, CSV files, JSON files. XML files, or the like. In some embodiments, the data may involve a document, such as a contract. In some embodiments, the document may be an analog document, such as an analog contract. An analog document may refer to a document that is in a machine-readable format, such as PDF or DOC. In some embodiments, the data may involve log or configuration files, such as log files from another platform. In some embodiments, the received data may be stored in a memory location of a device accessing the smart contract platform, such as organization device 105; a device hosting the smart contract platform, such as processing device 101; or any other device in system 100, such as database 113. Generally, it may be understood that any data received by or inputted into the smart contract platform may be stored in a memory location of a device accessing the smart contract platform, a device hosting the smart contract platform, or any other device capable of storing data.

In some embodiments, the smart contract platform may further be configured to receive data from a device or platform automatically without manual user intervention. The smart contract platform may be configured to interface or communicate directly with a platform, such as a controls provider platform, and receive technical controls status data associated with the connected platform. For example, a user may run the smart contract platform on a device also running a controls provider platform, such as vendor device 109, and the smart contract platform may receive technical controls status data directly and automatically from the controls provider platform.

In some embodiments, the smart contract platform may further be configured to involve an interactive user interface, such as a web application or a mobile application. The interactive user interface may be displayed on a visual display, such as a screen, associated with a device running or accessing the smart contract platform, such as user device 110. In some embodiments, the interactive user interface may further be configured to involve a number of user-interactive elements. The user-interactive elements may be configured to facilitate the creation, implementation, operation and/or display of a smart contract. For example, a user may interact with an upload element to upload a file containing data to the smart contract platform. A user may upload a file via an HTML form, an API, File Transfer Protocol (FTP), or any other method or means for uploading a file.

In some embodiments, the smart contract platform may further be configured to interface directly with another platform. For example, the smart contract platform may be configured to connect with a controls provider platform via a direct API connection. Thus, the smart contract platform may receive technical controls status data directly from controls provider platform.

In some embodiments, the interactive user interface may further be configured to involve a questionnaire. A questionnaire may involve a series of questions posed by one party of a contract to the other party of the contract. Further, a questionnaire may be interactive such that a user may input data, via a text field, dropdown menu, or the like. For example, a user, such as a vendor, may interact with a questionnaire via vendor device 109 to input information regarding which controls provider platforms the vendor is implementing to satisfy each of a set of controls expectations enumerated in a smart contract.

In some embodiments, the interactive user interface may further be configured to involve a file reader. A file reader may be a text parsing tool configured to extract data from a file. In some embodiments, the file reader may involve a business rules engine to extract data from a file. The business rules engine may be configured to implement one or more business rules to extract data from a file. The data may involve technical controls expectations enumerated in a contract or consequences for one or more parties of the contract for defaulting on the technical controls expectations. The one or more business rules may rely upon or utilize simple keywords or phrases to extract references to specific technical controls expectations and their associated consequences from a contract. For example, the business rules engine may implement a business rule to identify each instance of the keyword “firewall” within three words of “active.” Further, a business rule may involve identifying instances of the phrase “vendor shall employ” and extracting nearby associated controls expectation, e.g., “data encryption at rest.”

In some embodiments, the file reader may involve a machine learning model. The machine learning model may be a large language model configured to perform natural language processing tasks. The machine learning model may be configured to identify and extract references to specific technical controls expectations and their associated consequences. For example, the machine learning model may identify the sentence “Vendor shall institute controls consistent with the control objectives set forth in ISO 27001.”

In some embodiments, the file reader may store the extracted technical controls expectations in a data structure. The extracted technical controls data may be extracted by a business rules engine, a machine learning model, or both. For example, the file reader may store the extracted technical controls expectation in a first library, as detailed and described below.

In some embodiments, the file reader may be configured to parse or analyze received data. The received data may include technical controls status data sent by a CCM platform, log or configuration files uploaded by a user, technical controls status data received from a controls provider platform, or any other data associated with technical controls. For example, the file reader may be configured to convert a received log file into a predefined file format, such as JSON.

In some embodiments, the interactive user interface may further be configured to display information to a user. Information may include a status of a smart contract, controls expectations associated with a smart contract, or any other information associated with smart contracts and the operation or execution thereof. For example, a user may run the smart contract platform on organization device 105 to view the status of a smart contract, such as what violations of conditions enumerated in the smart contract have occurred. In some embodiments, the smart contract platform may display information to only authorized users. Authorized users may include parties of the smart contract, an insurer of a party of the smart contract, or the like. In some embodiments, a party of the smart contract may grant access to at least part of the smart contract to another user. For example, an insured may grant an insurer access to a smart contract between the insured and a vendor of the insured.

In some embodiments, the smart contract platform may further be configured to generate a smart contract. Generating a smart contract may refer to generating or creating software code for a smart contract. In some embodiments, the smart contract platform converts identified or labeled technical controls expectations into executable software code for a smart contract. For example, the smart contract platform may convert a technical controls expectation into an if/then statement, e.g. “If vendor has not encrypted Customer Data, then instruct Accounts Payable System to deduct 3% from monthly services payment to vendor.” In some embodiments, generating a smart contract may further involve creating an indicator or signifier for each enumerated technical controls expectation. The smart contract platform may assign a compliance flag to each enumerated technical controls expectation that may become a default flag when an “if” condition of an if/else statement associated with the technical controls expectation is satisfied. For example, referring to the above if/else example, the smart contract platform may assign a compliance flag to the technical controls expectation that the vendor has encrypted Customer Data, and the smart contract platform may replace the compliance flag with a default flag if or when the vendor has not encrypted Customer Data, at which point the smart contract would execute software code to instruct Accounts Payable System to deduct 3% from monthly services payment to vendor. In some embodiments, the smart contract platform may send contract data to a machine learning model along with instructions to generate software code for a smart contract. In some embodiments, contract data may involve one or more of a contract, a template, a first library, or a second library. Further, in some embodiments, the smart contract platform may feed contract data as an input to a platform, device, or system. For example, the smart contract platform may send contract data to machine learning system 115 along with instructions to generate a smart contract.

In some embodiments, generating a smart contract may involve a template. A template may contain software code that may be used in any smart contract. The template may be predefined by a user and may contain designated or indicated locations for provisions related to technical controls expectations and their associated consequences for defaulting. For example, the smart contract platform may only generate software code associated with technical controls expectations and insert the generated software code into a template. In some embodiments, processing device 101 stores the template in a memory location.

In some embodiments, the smart contract platform may further be configured to involve a first library. The first library may be a product/frameworks/objectives library, which may refer to a library that contains a mapping of a set of controls expectations to a product or service capable of satisfying those controls expectations in an information technology environment (e.g., controls provider platform). For example, the first library may map a controls provider platform (e.g., antivirus platform) to one or more controls expectations (e.g., deploy the antivirus platform, run scans at appropriate intervals) and map the controls expectation to a controls framework (e.g., the expectation that Data Loss Prevention controls be instituted to satisfy the controls objectives in ISO 27001). Further, the first library may also involve data regarding the materiality of a control. In some embodiments, the materiality data may be inputted, uploaded, or otherwise supplied to the smart contract platform by a party of the smart contract. In some embodiments, the smart contract platform may involve predefined materiality data.

In some embodiments, processing device 101 may store the first library in a memory location. In some embodiments, the mappings stored in the first library may be predefined by a user, such as an organization. Further, in some embodiments, the mappings stored in the first library may be modified, updated, deleted, created, or the like by an authorized user.

In some embodiments, the smart contract platform may further be configured to involve a second library. The second library may be a parameters/settings/output library, which may refer to a library that contains data that define expected technical controls status data, such as parameters, configuration settings, expected log file output, or any other data associated with technical controls expectations, for a controls provider platform. Expected technical controls status data may involve examples of technical controls status data that is acceptable or satisfies technical controls expectations enumerated in a contract, such as a smart contract. In some embodiments, the technical controls expectations are defined by a user. For example, an organization may define and store acceptable technical controls expectations in the second library. Further, in some embodiments, the technical controls expectations stored in the second library may be modified, updated, deleted, created, or the like by an authorized user. In some embodiments, the smart contract platform may be configured to extract defined technical controls expectations from a document and to store them in the second library. For example, the smart contract platform may extract defined technical controls expectations using the file reader and an uploaded contract and store the extracted data in the second library. In some embodiments, processing device 101 may store the second library in a memory location.

In some embodiments, processing device 101 may be configured to function as an oracle in the smart contract blockchain network. An oracle, or oracle device, may refer to an entity or service that provides real-world data to a smart contract or receives data from a smart contract to be send to other devices. In some embodiments, the smart contract platform may send data to the smart contract. For example, the smart contract platform may send technical controls status data to the smart contract from a device, such as processing device 101. When the smart contract detects that a condition is met or not met based on the received data, the smart contract may self-execute one or more associated consequences. For example, if the smart contract detects that a firewall is not being implemented correctly or as enumerated by a vendor, the smart contract may self-execute by sending instructions to processing device 101 to enact a payment deduction from a vendor.

In some embodiments, the smart contract platform may be configured to validate received data before sending to the smart contract. Validating data may involve one or more types of data validation including data type validation, range validation, format validation, consistency validation, business logic validation, or any other method of data validation. For example, the smart contract platform may check received technical controls status data to make sure the data is of the correct type and origin to prevent accidental trigger.

In some embodiments, the smart contract platform may be configured to perform data sanitization. Data sanitization may refer to cleaning or validating data to prevent a security vulnerability. For example, the smart contract platform may remove or encode data using escape characters (e.g., backslash, backtick, or the like) to protect against an injection attack.

In some embodiments, the smart contract platform may further be configured to connect to a financial account. The smart contract platform may involve an API from a bank or financial institution. For example, the smart contract platform may integrate an API from a fiat-currency-based bank.

In some embodiments, the smart contract platform may further be configured to connect to invoicing or accounts payable management software. The smart contract platform may interface with invoicing or accounts payable management software to automatically implement provisions of the smart contract when executed. For example, the smart contract platform may send instructions to an accounts payable management software to deduct a percentage from a monthly service bill of a vendor when the vendor defaults on a provision of the smart contract.

In some embodiments, the smart contract platform may further be configured to allow an authorized user to change or to modify the visibility or accessibility of specified elements of the smart contract. An authorized user, such as an employee of an organization, may define some elements of a smart contract as public and available for any user to view and may define some elements of a smart contract as private and available for only certain users to view. For example, an organization may make payment details in a smart contract private to preserve confidentiality and allow the organization to effectively enter into a plurality of smart contracts with one or more vendors or insurers.

It may be understood that the smart contract platform may involve any combination of features or functions. The aforementioned features and functions are non-limiting examples of what the smart contract platform may include and are not exhaustive. Further, any of the aforementioned features and functions may be modified, duplicated, omitted, or combined to perform operations consistent with disclosed embodiments.

Processing device 103 represents one or more electronic devices configured to perform a task. Processing device 103 may include or one or more known processing devices, such as, for example, a processor. In some embodiments, processing device 103 may include any type of single or multi-core processor, mobile device microcontroller, central processing unit, or any circuitry that performs logic operations. In operation, processing device 103 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in processing device 103, or elsewhere.

In some embodiments, processing device 103 may be configured to run or host a platform configured to perform operations consistent with disclosed embodiments for use on a device, such as vendor device 109. In some embodiments, processing device 103 may be configured to run or host a continuous controls monitoring (CCM) platform. A CCM platform may refer to a platform configured to perform operations related to continuous controls monitoring.

Continuous controls monitoring may refer to the use of automated tools to determine and report, live, the operational status of technical controls that have been or will be applied to one or more computer-based systems. For example, a CCM platform may be configured to determine and report the user password strength or password change policy in effect on a group of computer servers, the last time a data backup was successfully completed, whether default administrative user accounts are disabled, or any other technical controls status data. In some embodiments, a CCM platform may be configured to gather or to report data about any number of technical controls across a plurality of devices or computer-based systems. For example, a plurality of vendor devices 109 may run the CCM platform. In some embodiments, the CCM platform may be configured to gather or report status data on technical controls as enumerated in a smart contract.

In some embodiments, the CCM platform may further be configured to communicate or interface with a platform. For example, the CCM platform may be configured as an API or similar connection to a control provider platform and determine or record technical controls status data in real time.

In some embodiments, the CCM platform may further be configured to send data to another platform or device. For example, the CCM platform may send or report gathered technical controls status data to the smart contract platform. Further, the CCM platform may send the technical controls status data to a database, such as database 113.

Organization device 105 represents a computing device configured to perform one or more processes consistent with the disclosed embodiments. For example, organization device 105 may be implemented as a notebook computer, a mobile device with computing ability, a desktop computer, tablet, or the like. Organization device 105 may include a visual display, such as a screen, touchscreen, monitor, or the like, which may display information to the user. Organization device 105 may communicate with processing device 101 using a wireless network, a mobile network, a satellite network, or the like. In operation, organization device 105 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in organization device 105, or elsewhere. In some embodiments, organization device 105 may be configured to run software code associated with the smart contract.

In some embodiments, organization device 105 may be configured to receive data. Organization device 105 may receive data indicating violation of one or more technical control expectations enumerated in a smart contract and automatically adjust vendor payment. For example, upon self-execution of a smart contract, organization device 105 may receive instructions to deduct a predefined percentage from a vendor's monthly service bill.

Insurer device 107 represents a computing device configured to perform one or more processes consistent with the disclosed embodiments. For example, organization device 105 may be implemented as a notebook computer, a mobile device with computing ability, a desktop computer, tablet, or the like. Insurer device 107 may include a visual display, such as a screen, touchscreen, monitor, or the like, which may display information to the user. Insurer device 107 may communicate with processing device 101 using a wireless network, a mobile network, a satellite network, or the like. In operation, insurer device 107 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in insurer device 107, or elsewhere. In some embodiments, insurer device 107 may be configured to run software code associated with the smart contract.

In some embodiments, insurer device 107 may be configured to receive data. For example, upon self-execution of a smart contract, insurer device 107 may receive instructions to initiate an insurance re-rating or underwriting process. In some embodiments, insurer device 107 may be configured to base pricing or availability of insurance upon the received data. For example, insurer device 107 may receive data indicating one or more violations of technical control expectations enumerated in a smart contract and automatically adjust the cost or availability of insurance to an insured.

Vendor device 109 represents a computing device configured to perform one or more processes consistent with the disclosed embodiments. For example, organization device 105 may be implemented as a notebook computer, a mobile device with computing ability, a desktop computer, tablet, or the like. Vendor device 109 may include a visual display, such as a screen, touchscreen, monitor, or the like, which may display information to the user. Vendor device 109 may communicate with processing device 101 using a wireless network, a mobile network, a satellite network, or the like. In operation, vendor device 109 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in vendor device 109, or elsewhere. In some embodiments, vendor device 109 may be configured to run software code associated with the smart contract.

In some embodiments, vendor device 109 may be configured to receive data. For example, upon self-execution of a smart contract, vendor device 109 may receive a notice of default.

User device 110 represents a computing device configured to perform one or more processes consistent with the disclosed embodiments. For example, organization device 105 may be implemented as a notebook computer, a mobile device with computing ability, a desktop computer, tablet, or the like. User device 110 may include a visual display, such as a screen, touchscreen, monitor, or the like, which may display information to the user. User device 110 may communicate with processing device 101 using a wireless network, a mobile network, a satellite network, or the like. In operation, user device 110 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in user device 110, or elsewhere. In some embodiments, user device 110 may be configured to run software code associated with the smart contract. In some embodiments, user device 110 may be operated by a non-party user of a smart contract, such as a customer of the organization.

Network. 111 represents an electronic network for transmitting data between electronic devices. Network 111 may be implemented as one or more of the Internet, an intranet, a private link (such as a fiber optic network connecting remote sites), or the like. Network 111 may comprise wired links, wireless links, or a combination of wired and wireless links between the devices in system 100 (as well as other, unpictured devices).

In some embodiments, one or more devices connected to network 111 may function as a node in the same blockchain network. The blockchain network may include the blockchain network that stores a smart contract.

In some embodiments, network 111 may be a public blockchain network that allows any device in system 100 (as well as other, unpictured devices) access. As a public blockchain network, users who are not a party or counterparty of a smart contract to view the smart contract. For example, while an organization may enter into a smart contract with an insurer or a vendor, a customer of the organization may use a device, such as user device 110, to access or view the smart contract.

In some embodiments, network. 111 may be a private blockchain network that allows only authorized devices access. As a private blockchain network, an administrative user may decide to which other users to grant access. For example, an insurer may host, using one or more insurer devices 107, a private blockchain network containing a smart contract and only grant access to an insured and a vendor.

Database 113 represents one or more devices configured to store data. A database may refer to an electronic filing system that stores data in a structured way. Examples of databases may include relational databases, NoSQL databases, graph databases, in-memory databases, or the like. Database 113 may be, in some embodiments, a device storing data in one or more of a relational database, a non-relational database, a flat file, a CSV (comma separated value) file, a Microsoft Excel file, or the like. In operation, database 113 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in database 113, of elsewhere.

In some embodiments, database 113 may be configured to store a template for a smart contract. In some embodiments, database 113 may be configured to store the first library. In some embodiments, database 113 may be configured to store the second library. In some embodiments, database 113 may store one or more files uploaded to the smart contract platform. In some embodiments, database 113 may store technical controls status data received by the smart contract platform.

Machine learning system 115 represents one or more electronic devices that provide functionality for a making predictions, decisions, or inferences based on data. Machine learning system 115 may include or one or more known processing devices, such as, for example, a processor. In some embodiments, machine learning system 115 may include any type of single or multi-core processor, mobile device microcontroller, central processing unit, or any circuitry that performs logic operations.

In operation, machine learning system 115 may execute computer instructions (e.g., program codes) and may perform functions in accordance with techniques described herein. Computer instructions may include routines, programs, objects, components, data structures, procedures, modules, and functions, which may perform particular processes described herein. In some embodiments, such instructions may be stored in machine learning system 115, or elsewhere. Machine learning system 115 may be configured to receive input data from other devices such as processing device 101, processing device 103, and the like.

Machine learning system 115 may be configured to execute computer instructions for a machine learning model. A machine learning model may refer to a computational model or algorithm that is trained to perform a specific task without being explicitly programmed for that task using learned patterns and relationships to make predictions or decisions. In some embodiments, the machine learning model may be implemented as a large language model, such as GPT-3, GPT-4, BERT, XLNet, or the like. Large language model may refer to a type of machine learning model designed to analyze, understand, and generate human-like language via natural language processing tasks. In some embodiments, the machine learning model is a semi-supervised large language model. For example, the machine learning model may be primarily trained on unlabeled data and then fine-tuned in a supervised manner, such as GPT-3.5 or the like.

In some embodiments, the machine learning model may be trained to analyze a file. Analyzing a file may involve identifying and extracting specified keywords or phrases. Machine learning system 115 may use a file as an input to the machine learning model. For example, machine learning system 115 may use a contract as an input to the machine learning model with instructions to extract technical controls expectations and their associated consequences for defaulting.

In some embodiments, the machine learning model may be further trained to generate or produce software code for a smart contract. The machine learning model may be trained to generate software code based on received data, such as contract data. The machine learning model may use a template an outline or basis of a smart contract. For example, the machine learning model may generate software code defining technical controls expectations and associated consequences for defaulting only in indicated locations. Further, the machine learning model may analyze data in a first library to determine technical controls expectations and acceptable implementations of controls provider platforms to satisfy the technical controls expectations. For example, the machine learning model may use the first library to assist in identifying and determining technical controls expectations and associated consequences for defaulting in a contract. Further, the machine learning model may analyze data in a second library to determine examples of acceptable implementations of a controls provider platform or acceptable technical controls status data that does not result in a default. For example, the machine learning model may use the second library to determine thresholds or conditions for defaulting. The machine learning model may use contract data or any other data as inputs to determine technical controls expectations, conditions for defaulting on the determined technical controls expectations, and consequences for defaulting. Further, the machine learning model may generate, as an output, software code for a smart contract enumerating that information.

Machine learning system 115 may be configured to receive or send data from other devices, such as processing device 101, processing device 103, or the like. For example, machine learning system 115 may receive a file or data, such as contract data, from the smart contract platform and may send software code for a smart contract to the smart contract platform.

In some embodiments the functionality of processing device 101, processing device 103, database 113, and machine learning system 115 may be combined into a single device, may be divided up amongst a set of electronic devices, or some combination thereof. In some embodiments, one or more of processing device 101, processing device 103, organization device 105, insurer device 107, vendor device 109, user device 110, database 113, and machine learning system 115 may be modified, duplicated, or omitted. In some embodiments, one or more devices in system 100, such as processing device 101, processing device 103, organization device 105, insurer device 107, vendor device 109, or user device 110, may be configured to run one or more of: the smart contract platform, the CCM platform, or the smart contract.

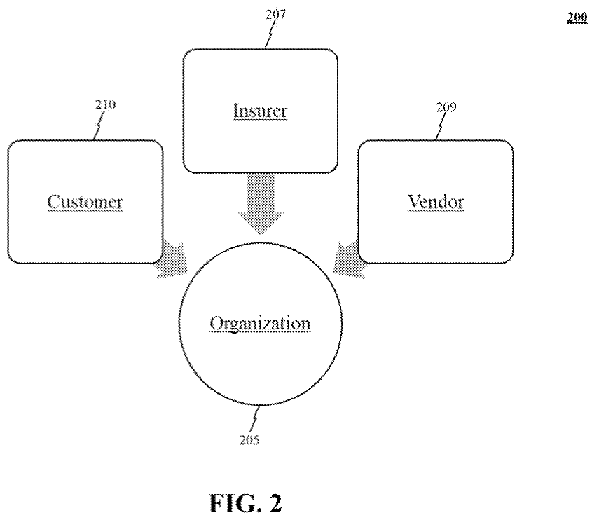

FIG. 2 is an example organizational relationship diagram 200, consistent with the disclosed embodiments. One or more entities depicted in diagram 200 may enter into a smart contract. The entities illustrated in diagram 200 are exemplary and non-limiting.

Organization 205 represents an entity that provides a product or service. Organization 205 may contract vendor 209 to provide a product or service. For example, organization 205 may employ vendor 209 to provide a product or service that may involve an amount of cybersecurity risk, such as a payroll service. Vendor 209 may, as required or detailed in a contract between organization 205 and vendor 209, implement cybersecurity controls, such as via one or more controls provider platforms (e.g., an antivirus software platform, a data loss prevention platform, a data backup platform, a file system encryption platform, or the like). Organization 205 may enter into a smart contract with another entity to demonstrate a robust ability to monitor vendors and protect against risks while limiting costs.

Insurer 207 represents an entity that provides insurance to another entity. Insurer 207 may provide insurance to organization 205. For example, insurer 207 may provide cyber-liability insurance to organization 205. Insurer 207 may enter into a smart contract with another entity, such as organization 205, to improve visibility into actual risk presented by that entity, such as vendor 209.

Vendor 209 represents an entity that provides a product or service. Vendor 209 may offer a service to organization 205. Further, vendor 209 may enter into a contract with organization 205 to provide a service with one or more cybersecurity stipulations or requirements. For example, vendor 209 may enter into a contract with organization 205 to provide a payroll service with a number of cybersecurity requirements, such as a required level of data encryption. Vendor 209 may utilize one or more controls provider platforms to satisfy that cybersecurity requirement to organization 205. Vendor 209 may enter into a smart contract with another entity to demonstrate compliance to organization 205 without the need for an audit.

Customer 210 represents an entity that uses or pays for the product or service of another entity. Customer 210 may want assurance that organization 205 is protecting their data or can maintain uptime and service level agreements (SLAs).

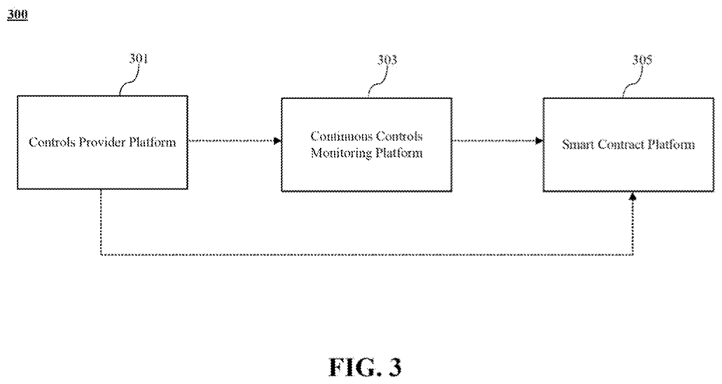

FIG. 3 is an example data flow process 300, consistent with the disclosed embodiments. In some embodiments, any element or connection of elements of process 300 may be duplicated, revised, omitted, or performed in an order different than the one depicted.

Controls provider platform 301 represents one or more platforms provided by a vendor to an organization. In some embodiments, each controls provider platform generates technical controls status data associated with that controls provider platform. For example, an antivirus software platform may generate technical controls status data detailing virus definition update status, scheduled scans, firewall settings, and the like. In some embodiments, technical controls status data may be represented in log or configuration files. For example, a data loss prevention platform may generate an incident log file and a policy configuration file.

In some embodiments, controls provider platform 301 may send technical controls status data to continuous controls monitoring (CCM) platform 303. In some embodiments, controls provider platform 301 may send technical controls status data directly to smart contract platform 305. For example, controls provider platform 301 may be configured to regularly send technical controls status data to smart contract platform 305 for environments or cases where no CCM platform 303 is available.

In some embodiments, CCM platform 303 may regularly query controls provider platform 301 for technical controls status data. For example, CMM platform 303 may query controls provider platform 301 for technical controls status data every 1 second, 1 minute, 1 hour, or any other length of time. In some embodiments, CCM platform 303 may send received technical controls status data to smart contract platform 305.

In some embodiments, smart contract platform 305 may regularly query controls provider platform 301 for technical controls status data. For example, smart contract platform 305 may query controls provider platform for technical controls status data every 1 second, 1 minute, 1 hour, or any other length of time. In some embodiments, smart contract platform 305 may send the technical controls status data to a smart contract. For example, smart contract platform 305 may send technical controls status data to a smart contract that determines whether technical controls expectations are met.

FIG. 4 is an example process 400 for a smart contract platform, consistent with the disclosed embodiments. In some embodiments, one or more steps of process 400 may be operated by one or more devices, such as processing device 101, database 113, or machine learning system 115. Process 400 may be the steps or operations of a platform hosted by processing device 101 or any other device. In some embodiments, any step of process 400 may be duplicated, revised, omitted, or performed in an order different than the one depicted.

In step 401, the smart contract platform receives a contract. In some embodiments, a user may upload a file containing the contract to the smart contract platform. In some embodiments, the smart contract platform may receive an email containing the contract, a Uniform Resource Locator (URL) linked to the contract, or receive the contract in another manner. In some embodiments, the smart contract platform may store the file in a memory location in the device running the smart contract platform, such as organization device 105. In some embodiments, the smart contract platform may store the file in a memory location in the device hosting the smart contract platform, such as processing device 101. In some embodiments, the smart contract platform may store the file in a memory location in another device, such as database 113.

In step 403, the smart contract platform authors and implements a smart contract based on the received contract. In some embodiments, authoring a smart contract may involve parsing the received contract a plurality of times. First, the file reader of the smart contract platform may identify and extract keywords or phrases using a business rules engine. For example, the file reader may search for the term “encryption” within two words of “rest.” Then the smart contract platform may send a combination of: the file-reader-identified technical controls expectations, the received contract, the template, and the first library to machine learning system 115 with instructions to identify technical controls expectations and to generate software code for a smart contract. The smart contract platform may be configured to receive the output from the machine learning model.

In some embodiments, authoring the smart contract may involve the smart contract platform using the first library, the second library, and/or the questionnaire. The smart contract platform may associate technical controls expectations with specific controls provider platforms in use by a vendor and the expected technical controls status data from those controls provider platforms when controls are implemented and operating properly. For example, the smart contract platform may be configured to generate software code for a smart contract enumerating the technical controls expectations and consequences for defaulting, such as in “if/then” statements. An example “if/then” statement may read “If Vendor has not encrypted Customer Data, then Accounts Payable System to deduct 3% from monthly Services payment to Vendor.”

In some embodiments, the smart contract platform may author the smart contract to implement a standard convention, custom, or practice for security terms. The standard convention may involve standard terminology, phrasing, or wording that lends itself to less ambiguity.

In some embodiments, implementing the smart contract may involve the smart contract platform displaying or sending the smart contract to each involved party for review and approval. Non-approving parties may submit or suggest changes to the smart contract to the smart contract platform. Once approved by all parties, the smart contract platform may deploy the smart contract to a connected blockchain network or platform.

In step 405, the smart contract platform receives technical controls status data. The smart contract platform may receive technical controls status data from a controls provider platform directly, via upload by a user, or through a CCM platform. When receiving technical controls status data directly or via upload by a user, the file reader of the smart contract platform may parse the technical controls status data. Parsing the technical controls status data may involve converting to a specified file format. Parsing may also involve identifying and extracting relevant information from the technical controls status data. For example, if a user uploads log and configuration files associated with a controls provider platform to the smart contract platform, the file reader may analyze and convert the files to a predefined format.

Step 405 further involves the smart contract platform sending the technical controls status data to the smart contract.

In step 407, the smart contract platform may receive data from the smart contract. The smart contract may determine a default has occurred based on the technical controls status data and send instructions to the smart contract platform, as exemplified and described with respect to FIG. 5. The instructions may then be sent to other devices, platforms, or systems to fulfill the terms of the smart contract. For example, the instructions may be sent to the vendor to notify the failure to comply with the technical controls expectations. Further, the instructions may be sent to the organization to automatically deduct payment to the vendor.

In step 409, the smart contract platform displays results data. In some embodiments, results data may involve a status of a smart contract, one or more technical controls expectations enumerated in the smart contract, technical controls tracking data, or technical controls statistical data. In some embodiments, the smart contract platform may be configured to display the performance versus contract expectations. For example, the smart contract platform may display, via a graph, table, or any other visual representation of data, the number of times a vendor has defaulted for each technical controls expectation. The smart contract platform may be configured to update the displayed results data based on received data from the smart contract.

In some embodiments, displaying results data may involve the first library, the second library, technical controls status data, or any other related data to indicate the operational status of a given technical control. For example, the smart contract platform may display the number of times an antivirus software platform successfully blocked a virus. In some embodiments, a user may view results displayed on the smart contract platform to determine whether prospective counterparties are likely to adhere to contractual obligations. For example, an organization wishing to enter into contract with a vendor may use the smart contract platform to view the results of any public smart contracts to which that vendor is party.

FIG. 5 is an example process 500 for operation of a smart contract by a device, consistent with the disclosed embodiments. In some embodiments, the device may be a device, such as a device in system 100 like as processing device 101 or organization device 105, that performs smart contract operations. In some embodiments, any step of process 500 may be duplicated, revised, omitted, or performed in an order different than the one depicted.

In step 501, the device receives technical controls status data from a smart contract platform.

In step 503, the device compares the received technical controls status data against technical controls expectations. The device may execute software code of a smart contract to determine if any of the received technical controls status data meets a condition enumerated in the smart contract. For example, the device may feed the received technical controls status data as an input into the smart contract to automatically determine whether a default has occurred.

In step 505, the device may then determine whether a default has occurred. If the technical controls status data meets the technical controls expectations, the device may send data to the smart contract platform indicating no defaults. If the technical controls status data does not meet the technical controls expectations (i.e., the device determines a default has occurred), the device may send data to the smart contract platform indicating a default and may automatically activate an associated consequence. For example, if the device receives technical controls status data indicating a firewall is not being implemented as enumerated in the smart contract, the device may determine a default has occurred. The device may then execute software code in the smart contract associated with the determined fault. In some embodiments, the executed software code may involve sending signals to one or more other devices. For example, the device may send instructions to organization device 105 to deduct an amount from a vendor's monthly service bill, a notification to vendor device 109 to remedy the detected fault, or instructions to insurer device 107 to automatically adjust an insurance rate. Further, the device may send instructions to insurer device 107 to automatically adjust the availability of insurance and notify organization device 105 or vendor device 109 of the adjustment.

Certain features which, for clarity, are described in this specification in the context of separate embodiments may also be provided in combination in a single embodiment. Conversely, various features which, for brevity, are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While the present disclosure has been shown and described with reference to particular embodiments thereof, it will be understood that the present disclosure can be practiced, without modification, in other environments. The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments.

Computer programs based on the written description and disclosed methods are within the skill of an experienced developer. Various programs or program modules can be created using any of the techniques known to one skilled in the art or can be designed in connection with existing software. For example, program sections or program modules can be designed in or by means of .Net Framework, .Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods or processes may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A system for controlling and minimizing risk associated with technical controls implemented in a data sensitive system against cyberattack, comprising:
at least one processor; and
at least one non-transitory computer-readable medium containing instructions that, when executed by the system, cause the system to perform operations comprising:
receiving operational data related to an operation of one or more technical controls installed in a data sensitive system, the one or more technical controls provided by a provider;
processing the operational data;
sending the processed operational data to a first device, the first device configured to perform smart contract operations;
detecting, by the first device, a fault in the operation of one or more technical controls based on the processed operational data;
sending, by the first device, first signals to an oracle device;
sending, by the oracle device, second signals to one or more devices; and
displaying results data.

2. The system of claim 1, wherein the operations further comprise generating a smart contract.

3. The system of claim 2, wherein generating a smart contract comprises feeding contract data into one or more of:
a machine learning model; and
a business rules engine.

4. The system of claim 3, wherein contract data comprises one or more of:
a contract;
a template;
a first library, wherein the first library contains a mapping of a set of operational data expectations to one or more products and services capable of satisfying the set of operational data expectations and a mapping of the set of operational data expectations to one or more frameworks; and
a second library, wherein the second library contains acceptable operational data values for a set of operational data expectations.

5. The system of claim 1, wherein the first signals comprise data indicating a fault in one or more technical controls.

6. The system of claim 1, wherein the second signals comprise instructions to the one or more devices to perform one or more of:
instructing an owner device to automatically adjust a bill to the provider;
sending a notification to a provider device detailing the fault;
instructing an insurer device to automatically adjust pricing and availability of insurance based on the detected fault or the results data;
notifying an owner device of the adjustment; and
notifying a vendor device of the adjustment.

7. The system of claim 1, wherein the results data comprise one or more of:
a status of the smart contract;
an operational data expectation;
technical controls tracking data; and
technical controls statistical data.

8. A method for controlling and minimizing risk associated with technical controls implemented in a data sensitive system against cyberattack, comprising:
receiving operational data related to an operation of one or more technical controls installed in a data sensitive system, the one or more technical controls provided by a provider;
processing the operational data;
sending the processed operational data to a first device, the first device configured to perform smart contract operations;
detecting, by the first device, a fault in the operation of one or more technical controls based on the processed operational data;
sending, by the first device, first signals to an oracle device;
sending, by the oracle device, second signals to one or more devices; and
displaying results data.

9. The method of claim 8, wherein the operations further comprise generating a smart contract.

10. The method of claim 9, wherein generating a smart contract comprises feeding contract data into one or more of:
a machine learning model; and
a business rules engine.

11. The method of claim 10, wherein contract data comprises one or more of:
a contract;
a template;
a first library, wherein the first library contains a mapping of a set of operational data expectations to one or more products and services capable of satisfying the set of operational data expectations and a mapping of the set of operational data expectations to one or more frameworks; and
a second library, wherein the second library contains acceptable operational data values for a set of operational data expectations.

12. The method of claim 8, wherein the first signals comprise data indicating a fault in one or more technical controls.

13. The method of claim 8, wherein the second signals comprise instructions to the one or more devices to perform one or more operations of:
instructing an owner device to automatically adjust a bill to the provider;
sending a notification to a provider device detailing the fault;
instructing an insurer device to automatically adjust pricing and availability of insurance based on the detected fault or the results data;
notifying an owner device of the adjustment; and
notifying a vendor device of the adjustment.

14. The method of claim 8, wherein the results data comprise one or more of:
a status of the smart contract;
an operational data expectation;
technical controls tracking data; and
technical controls statistical data.

15. A non-transitory computer-readable medium for controlling and minimizing risk associated with technical controls implemented in a data sensitive system against cyberattack including instructions that, when executed by at least one processor, cause the at least one processor to perform operations comprising:
receiving operational data related to an operation of one or more technical controls installed in a data sensitive system, the one or more technical controls provided by a provider;
processing the operational data;
sending the processed operational data to a first device, the first device configured to perform smart contract operations;
detecting, by the first device, a fault in the operation of one or more technical controls based on the processed operational data;
sending, by the first device, first signals to an oracle device;
sending, by the oracle device, second signals to one or more devices; and
displaying results data.

16. The non-transitory computer-readable medium of claim 15, wherein the operations further comprise generating a smart contract by feeding contract data into one or more of:
a machine learning model; and
a business rules engine.

17. The non-transitory computer-readable medium of claim 16, wherein contract data comprises one or more of:
a contract;
a template;
a first library, wherein the first library contains a mapping of a set of operational data expectations to one or more products and services capable of satisfying the set of operational data expectations and a mapping of the set of operational data expectations to one or more frameworks; and
a second library, wherein the second library contains acceptable operational data values for a set of operational data expectations.

18. The non-transitory computer-readable medium of claim 15, wherein the first signals comprise data indicating a fault in one or more technical controls.

19. The non-transitory computer-readable medium of claim 15, wherein the second signals comprise instructions to the one or more devices to perform one or more operations of:
instructing an owner device to automatically adjust a bill to the provider;
sending a notification to a provider device detailing the fault;
instructing an insurer device to automatically adjust pricing and availability of insurance based on the detected fault or the results data;
notifying an owner device of the adjustment; and
notifying a vendor device of the adjustment.

20. The non-transitory computer-readable medium of claim 15, wherein the results data comprise one or more of:
a status of the smart contract;
an operational data expectation;
technical controls tracking data; and
technical controls statistical data.
